(19) United States
(12) Patent Application Publication
(10) Pub. No.: US 2006/0041703 A1
(43) Pub. Date: Feb. 23, 2006

(54) Computer systems with multiple system configurations

(75) Inventor: Ying-Chun Tseng, Taipei City (TW)

Correspondence Address: BIRCH STEWART KOLASCH & BIRCH, PO BOX 747, FALLS CHURCH, VA, 22040-0747, US

(73) Assignee: ASROCK INCORPORATION

(21) Appl. No.: 11/184,792

(22) Filed: Jul. 20, 2005

(30) Foreign Application Priority Data
Aug. 18, 2004 (TW) 93125038

(51) Int. Cl. G06F 13/36; G06F 13/00

(52) U.S. Cl. 710/306; 710/316

(57) ABSTRACT

A module with a first Northbridge area comprising a first CPU, a first system memory, a first accelerated graphics port and a first Northbridge is provided. A motherboard with a Southbridge and a second Northbridge area comprising a second CPU, a second system memory, a second accelerated graphics port and a second Northbridge is also provided. A bus switching device and an expansion connector for connection of the module is provided on the motherboard. When the module is not connected the expansion connector, the second Northbridge area is connected with the Southbridge and the expansion connector is disconnected from the Southbridge; and when the module is connected the expansion connector, the second Northbridge area is disconnected from the Southbridge, and the Southbridge is electrically connects with the expansion connector.

### BACKGROUND

The invention relates to a computer system with multiple system configurations, and more particularly, to methods and apparatuses providing multiple system configuration to a computer system.

FIG. 1 is a block diagram of a conventional computer motherboard. The motherboard comprises a Northbridge area 11 and a Southbridge area 12. The Northbridge area 11 comprises a CPU 111, a Northbridge 112, a system memory 113, an AGP device 114 and a Northbridge area control circuit 115. The Northbridge area control circuit 115 controls the power supply and thermal solution for the is Northbridge area 11. The Northbridge area 11 connects to the Southbridge area 12 using a bus 131. The signals on bus 131 combines the signals with which the Southbridge area 12 communicates the Northbridge 112 and the Northbridge area control circuit 115.

The system memory area 113 retains data required for programs when system power is ON. Single or multiple system memory buses on the motherboard connect to one or more memory devices such as a SDRAM bus and a DDR SDRAM bus on the motherboard. A Dual Channel system memory bus utilizes two independent memory controllers for improved system performance.

The Southbridge area 12 comprises a Southbridge 121, system input/output controllers 123 coupled to the Southbridge 121 via system input/output buses 133 and a Southbridge area control circuit 122 coupled to the Southbridge 121 via Southbridge control bus 132.

The system input/output controllers 123 controls interfaces with external devices. One or more system input/output buses each connect to one or more system input/output devices and may be a PCI bus and/or an ISA bus. Input/output connectors 124 connect to different input/output interface bus 134 respectively, and connect to the external devices/cables thereby.

Southbridge area control circuit 122 contains circuits controlling power and thermal solutions for the Southbridge area 12.

Conventional motherboards comprise core logic chipset and CPU configurations that cannot be changed. Installation of a CPU not compatible with the CPU socket requires the replacement of motherboard, and possibly related devices, representing considerable inconvenience and cost.

### SUMMARY

A module with a first Northbridge area comprising a first CPU, a first system memory, a first accelerated graphics port and a first Northbridge is provided. A motherboard with a Southbridge and a second Northbridge area comprising a second CPU, a second system memory, a second accelerated graphics port and a second Northbridge is also provided. A bus switching device and an expansion connector connecting the module is provided on the motherboard. When the module is not connected to the expansion connector, the second Northbridge area is connected with the Southbridge and the expansion connector is disconnected from the Southbridge. When the module is connected to the expansion connector, the second Northbridge area is disconnected from the Southbridge, and the Southbridge is electrically connects with the expansion connector.

Additional features and advantages of the invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### DESCRIPTION OF THE DRAWINGS

The accompanying drawings, incorporated in and constitute a part of this specification, illustrate embodiments of the invention and, together with the description, serve to explain the features, advantages, and principles of the invention.

FIG. 1 is a block diagram of a conventional computer system.

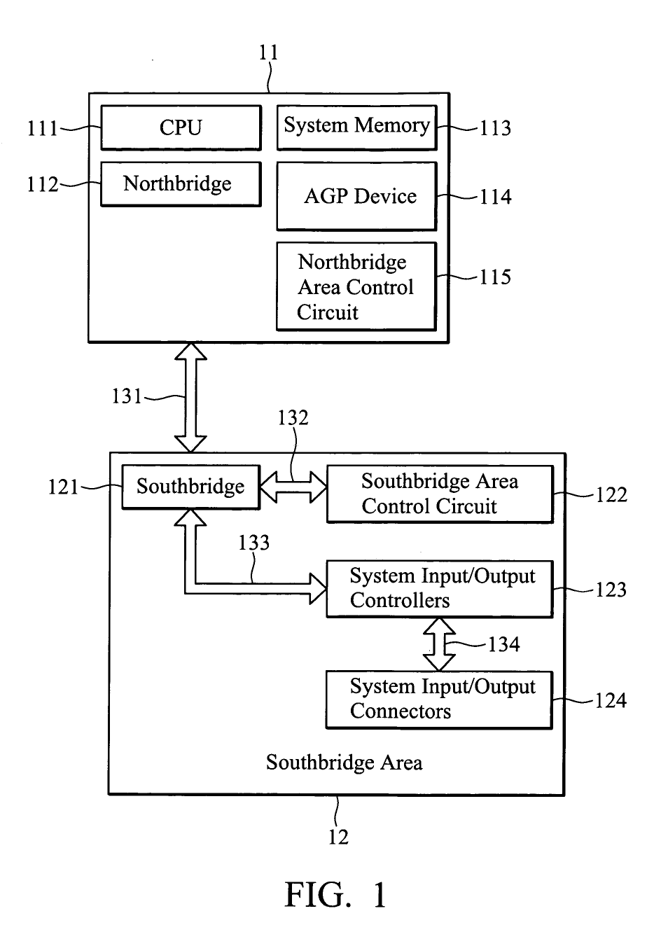

FIG. 2 is a block diagram of a motherboard according to an embodiment of the invention.

FIG. 3 is a block diagram of a module applied with the motherboard of FIG. 2.

FIG. 4 is a block diagram of a motherboard according to another embodiment of the invention.

FIG. 5 is a block diagram of a module applied with the motherboard of FIG. 4

### DETAILED DESCRIPTION

The invention is adaptive to change the CPU configuration in a computer system. But in some occasions, the system requires a different Northbridge to connect to a different kind of CPU. Various kind of Southbridge can support more than one type of Northbridge. Bus signals between Southbridge and Northbridge area comprising a CPU, a system memory, a accelerated graphics port and a Northbridge, switched to connect with another Northbridge area also comprising a CPU, a system memory, an accelerated graphics port and a Northbridge, allow an existing motherboard to accommodate a different CPU. A module is provided to carry Northbridge area. An expansion slot on the motherboard connects the module. When the module connects to the expansion slot, the Southbridge is disconnected from the onboard Northbridge area, and electrically connected to the expansion slot, to connect to the Northbridge area carried by the module. A bus switching device switches the connection of the Southbridge between the onboard Northbridge area and the expansion slot.

The bus switching device can be a set of jumpers set to connect the system core logic chipset to either the onboard CPU or the expansion slot, or a bus switching IC chip receiving a control signal generated in the motherboard, which sets the signal to a first state to control the bus switching IC to connect the Southbridge with the onboard Northbridge area when the expansion slot is empty, and sets the signal to a second state to control the bus switching IC to connect the core logic chipset with the expansion slot when the expansion slot connects to the module. The bus switching device disconnects the unused device and its related bus routing from the active bus, improving the signal integrity by preventing the loading and signal reflection caused by the unused device and the bus routing.

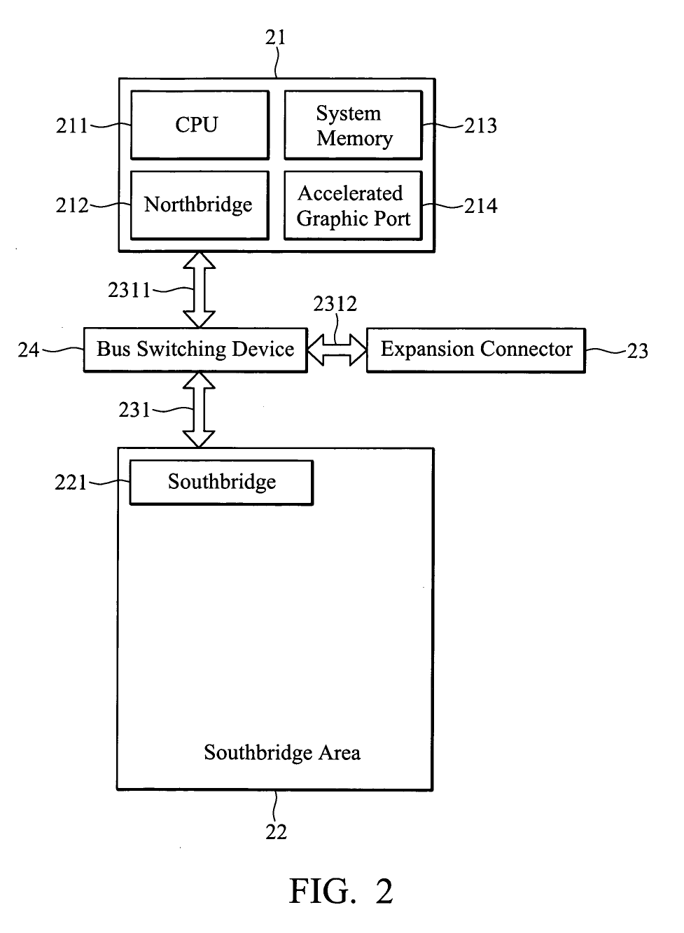

FIG. 2 is a block diagram of a motherboard according to an embodiment of the invention. The motherboard comprises a Northbridge area 21, a Southbridge area 22, a bus switching device 24, and an expansion slot 23.

The Northbridge area 21 comprises a CPU 211, a system memory 213, an accelerated graphics port 214, and a Northbridge 212. The Northbridge area 21 further comprises control circuits (not shown) controlling the power supply and thermal solutions on the Northbridge area 21. The CPU 211 can be assembled onboard or connect to the motherboard through an onboard CPU socket.

The Southbridge area 22 comprises a Southbridge 221. The Southbridge area 22 connects to the bus switching device 24 via bus 231. The bus switching device 24 connects to the Northbridge area 21 via the bus 2311 and the expansion slot 23 via bus 2312. The bus switching device 24 electrically connects the signals of the bus 231 with the signals of the bus 2311 if there is no device connected to the expansion slot 23. The Southbridge area 22 connects to the first Northbridge area 21 and forms a complete system structure that boots and computes normally.

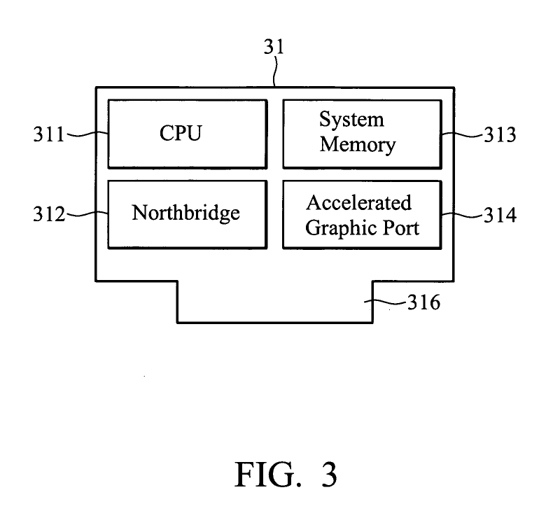

FIG. 3 is a block diagram of a module applicable with the motherboard of FIG. 2. The module 31 comprises a CPU 311, a system memory 313, an accelerated graphics port 314, a Northbridge 312 and a signal connector 316 connecting with the expansion slot 23. CPU 311 can be assembled onboard or connect to the module 31 through an onboard CPU socket.

The bus switching device 24 electrically connects the signals of the bus 231 with the signals of the bus 2312 when the expansion slot is connected to the upgrade module 31. The Southbridge area 22 connects to the upgrade module 31 and forms a complete system structure that boots and computes normally.

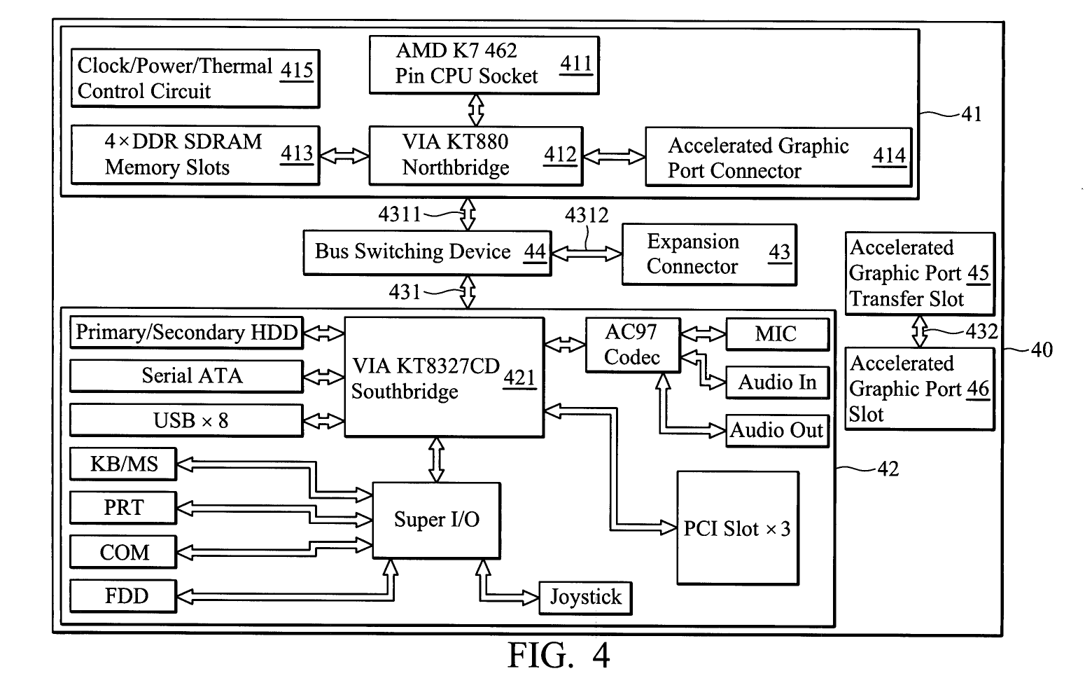

FIG. 4 shows a block diagram of a motherboard according to another embodiment of the invention. The motherboard comprises a Northbridge area 41, a Southbridge area 42, a bus switching device 44 and an expansion slot 43.

The Northbridge area 41 comprises an AMD K7 462 pin CPU socket 411, 4 DDR SDPAM slots 413, a first accelerated graphics port slot 414 and a VIA KT880 Northbridge 412. The first Northbridge area further comprises control circuits 415 controlling power supply and thermal solutions on the first CPU area 41.

According to the design of the AMD K7 462 pin CPU and the VIA KT880 Northbridge, 4 DDR SDPAM slots 413 are connected to VIA KT880 Northbridge 412 in this embodiment.

The Southbridge area 42 comprises a VIA KT8327CD Southbridge 421, which communicating the VIA KT880 Northbridge 412 using VIA V-LINK bus. The Southbridge area 42 further comprises all the other devices which aren't directly connected to the first Northbridge area 41. Southbridge area 42 connects to the bus switching device 44 via the bus 431 comprising the V-link bus signals and the clocks, powers and thermal control signals. The bus switching device 44 connects to the first Northbridge area 41 via the bus 4311 and to the expansion slot 43 via bus 4312. The bus switching device 44 electrically connects the signals of the bus 431 with the signals of the bus 4311 if the expansion slot 43 is not connected to any device. The Southbridge area 42 connects to the first Northbridge area 41 and forms a complete system structure that boots and computes normally.

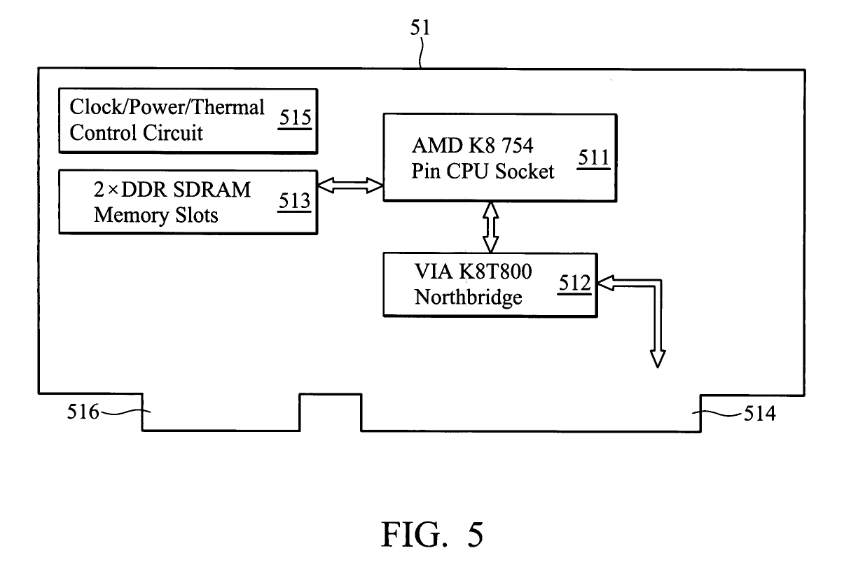

FIG. 5 is a block diagram of a module 51 applicable with the motherboard of FIG. 4. The module 51 comprises a VIA K8 754 pin CPU socket 511, 2 DRR SDRAM system memory slots 513, an accelerated graphics port connector 514 and a VIA K8T800 Northbridge 512 and a signal connector 516 to connect with the expansion slot 43.

According to the design of the AMD K8 754 pin CPU and the VIA K8T800 Northbridge, 2 DDR SDRAM slots 513 are connected to AMD K8 754 pin CPU socket 511 in this embodiment.

The bus switching device 44 electrically connects the signals of the bus 431 with the signals of the bus 4312 if the expansion slot is connected to the upgrade module 51. The Southbridge area 42 connects to the upgrade module 51 and forms a complete system structure that boots and computes normally.

Please notice in this embodiment, when the module 51 connects to the motherboard 40, the accelerated graphics port signals controlled by the VIA K8T800 Northbridge 512 connects to the accelerated graphics port connector 514, and connected to an accelerated graphics port transfer slot 45 which electrical connects to the accelerated graphics port slot 46. Accelerated graphics port devices must plug in the AGP slot 46 rather than the AGP connector 414 when the upgrade module 51 connected to the motherboard 40, because the bus 4311 would be disconnected from the system and the VIA KT880 Northbridge 412 and its accelerated graphics port controller would not work at that time. According the design of this embodiment, the size of the upgrade module 51 can be reduced for there is no accelerated graphics port slot required on the upgrade module 51, and the AGP device can still using the original computer system mechanism for add-on cards designed for the motherboard 40.

The invention enables replacement of CPUs in a computer system, reducing cost and inconvenience.

When the invention has been described by way of example and in terms of preferred embodiment, it is to be understood that the invention is not limited thereto. Those who are skilled in this. technology can still make various alterations and modifications without departing from the scope and spirit of this invention. Therefore, the scope of the present invention shall be defined and protected by the following claims and their equivalents.

What is claimed is:

1. A method of providing multiple system configurations for a computer system; the method comprising:
providing a module with a first Northbridge area comprising a first CPU, a first system memory, a first accelerated graphics port and a first Northbridge;
providing a motherboard with a Southbridge and a second Northbridge area comprising a second CPU, a second system memory, a second accelerated graphics port and a second Northbridge;
providing a bus switching device on the motherboard;
providing an expansion connector on the motherboard for connection of the module;
electrically connecting the second Northbridge area with the Southbridge by switching the bus switching device, and electrically disconnecting the expansion connector from the Southbridge, when the module is not connected to the expansion connector; and
electrically disconnecting the second Northbridge area from the Southbridge by switching the bus switching device, and electrically connecting the Southbridge with the expansion connector, when the module is connected to the expansion connector.

2. A motherboard suitable for multiple system configurations by connecting to a module with a first Northbridge area comprising a first CPU, a first system memory, a first accelerated graphics port and a first Northbridge; the motherboard comprising:
a second Northbridge area, comprising a second CPU, a second system memory, a second accelerated graphics port and a second Northbridge;
a Southbridge;
an expansion connector for connection of the module; and
a bus switching device selectively coupled between the second Northbridge area, the Southbridge and the expansion connector; wherein the bus switching device electrically connects the second Northbridge area to the Southbridge when the module is not connected to the expansion connector and electrically connects the expansion connector to the Southbridge when the module is connected to the expansion connector.

3. The motherboard as claimed in claim 2, further comprising an accelerated graphics port transfer slot for extra connection of the module, and an additional accelerated graphics port slot connected to the accelerated graphics port transfer slot; wherein when the module connected to the expansion slot, the first accelerated graphics port electrically connects to the additional accelerated graphics port slot.

4. The motherboard as Claimed in claim 2, wherein the bus switching device is a set of jumpers.

5. The motherboard as Claimed in claim 2, wherein the bus switching device is a bus switching Integrated Circuit controlled by a switching signal generated in the motherboard.

6. The motherboard as Claimed in claim 5, wherein the switching signal is in a first state if the module is not connected to the expansion connector and in the second state if the module is connected; wherein the bus switching IC connects the Southbridge with the second Northbridge area when the switching signal is in the first state, and connects the Southbridge with the expansion connector when the switching signal is in the second state.

7. A computer system with multiple system configurations comprising:
a module with a first Northbridge area comprising a first CPU, a first system memory, a first accelerated graphics port and a first Northbridge; and
a motherboard comprising:
a second Northbridge area, comprising a second CPU, a second system memory, a second accelerated graphics port and a second Northbridge;
a Southbridge;
an expansion connector for connection of the module; and
a bus switching device selectively coupled between the second Northbridge area, the Southbridge and the expansion connector; the bus switching device electrically connects the second Northbridge area to the Southbridge when the module is not connected to the expansion connector and electrically connects the expansion connector to the Southbridge when the module is connected to the expansion connector.

8. The computer system as claimed in 7, wherein the motherboard further an accelerated graphics port transfer slot for extra connection of the module and an additional accelerated graphics port slot connected to the accelerated graphics port transfer slot; when the module connected to the expansion slot and the accelerated graphics port transfer slot, the first accelerated graphics port electrically connects to the additional AGP slot.

9. The computer system as claimed in 7, wherein the bus switching device is a set of jumpers.

10. The computer system as claimed in 7, wherein the bus switching device is a bus switching Integrated Circuit controlled by a switching signal generated in the motherboard.

11. The computer system as claimed in 10, wherein the switching signal is in a first state if the module is not connected to the expansion connector and in the second state if the module is connected; the bus switching IC connects the Southbridge with the second Northbridge area when the switching signal is in the first state, and connects the Southbridge with the expansion connector when the switching signal is in the second state.
